(19) United States
(12) Patent Application Publication
(10) Pub. No.: US 2026/0178203 A1
(43) Pub. Date: Jun. 25, 2026

(54) STATUS POLLING PARAMETER ADJUSTMENT BASED ON DEVICE TEMPERATURE

(71) Applicant: Micron Technology, Inc., Boise, ID (US)

(72) Inventors: Scott Anthony Stoller, Boise, ID (US); Brent Carl Byron, Boise, ID (US); Robert Winston Mason, Boise, ID (US)

(21) Appl. No.: 19/060,459

(22) Filed: Feb. 21, 2025

Related U.S. Application Data
(60) Provisional application No. 63/737,341, filed on Dec. 20, 2024.

(51) Int. Cl. G06F 3/06

(52) U.S. Cl. CPC G06F 3/0619; G06F 3/0659; G06F 3/0679

(57) ABSTRACT

A temperature of at least a portion of a memory device is determined. One or more polling parameters for the memory device are adjusted based on the temperature thereby resulting in one or more adjusted polling parameters. The memory device is polled for status information about an array operation being performed at the memory device in accordance with the one or more adjusted polling parameters.

### PRIORITY APPLICATION

This application claims the benefit of priority to U.S. Provisional Application Ser. No. 63/737,341, filed Dec. 20, 2024, which is incorporated herein by reference in its entirety.

### TECHNICAL FIELD

Embodiments of the disclosure relate generally to memory sub-systems and, more specifically, to techniques for adjusting polling parameters based on a memory device temperature.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory subsystem to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some examples.

FIGS. 2A, 2B, and 2C are data flow diagrams illustrating interactions between components in the memory sub-system in adjusting status polling parameters based on memory device temperature, in accordance with some examples.

FIG. 3 are flow diagrams illustrating an example method for adjusting status polling parameters based on memory device temperature, in accordance with some examples.

FIG. 4 is a block diagram of an example computer system in which embodiments of the present disclosure may operate.

### DETAILED DESCRIPTION

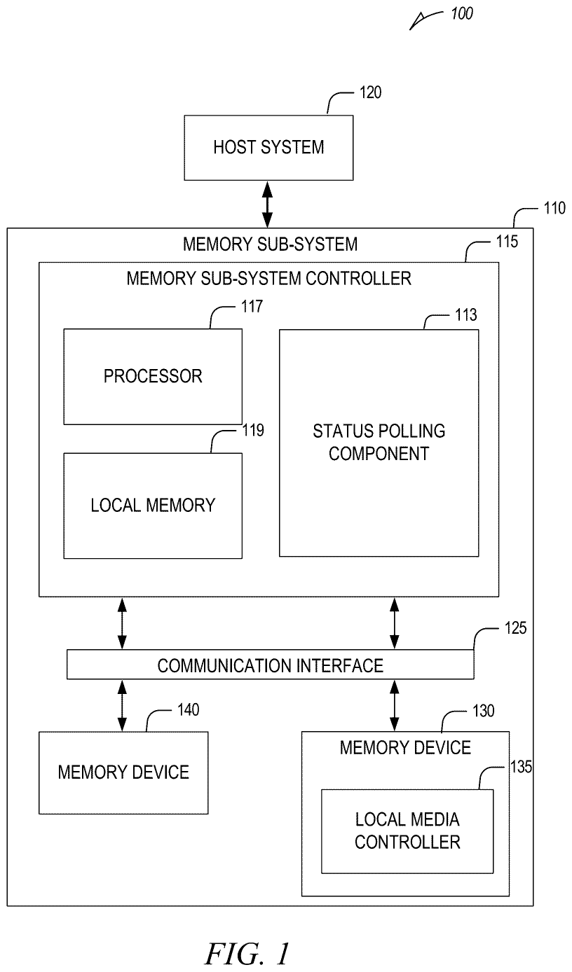

Aspects of the present disclosure are directed to an approach for adjusting polling parameters of a memory device in a memory sub-system. A memory sub-system can be a memory device (e.g., solid-state drive [SSD]), a memory module, or a combination of a memory device and memory module. Examples of memory devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. A NAND memory device can include multiple NAND dies. Each die may include one or more planes, and each plane includes multiple blocks. Each block includes an array that includes pages (rows) and strings (columns). A string includes a plurality of memory cells connected in series. A memory cell (also referred to herein simply as a “cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values.

Various memory array operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages (Vt) of the cells in each page according to the value that the cells are intended to represent. As the programming sequence progresses, the voltage level of the programming pulses increase until a target voltage level for each cell is reached. In some instances, memory subsystems may need to temporarily suspend ongoing operations to service other requests. The management of these suspend operations requires consideration of factors such as forward progress on the original operation and efficient resumption of suspended tasks.

Memory subsystems commonly employ status polling mechanisms to determine when array operations on memory devices are complete. Status polling involves sending operation status requests to a memory device at regular intervals, with the device responding to indicate whether it is ready or still processing an operation. Operation times in NAND memory devices can vary based on multiple factors including the specific operation being performed, device characteristics, and environmental conditions such as temperature. For example, array operation completion times may differ significantly between hot and cold temperature conditions.

Status polling presents competing considerations between latency and efficiency. Frequent polling can increase bus utilization, while infrequent polling may delay recognition of operation completion. The timing of status polling operations affects both system performance and resource utilization. Conventional memory subsystems typically implement fixed parameters for status polling across all operating conditions.

Aspects of the present disclosure address the above and other issues with a memory sub-system that adjusts status polling parameters (also referred to herein simply as “polling parameters) based on memory device temperature. A status polling component of the memory sub-system determines a temperature of at least a portion of a memory device and adjusts polling parameters based on the temperature. The temperature may be obtained from one or more temperature sensors of the memory device or derived based on output from a temperature sensor of the status polling component or a standalone temperature sensor. The polling parameters include an initial delay parameter that defines a delay between initiating an array operation and sending an initial operation status command, and a polling interval parameter that defines an interval between sending follow-up operation status commands. The adjustment of polling parameters can be implemented through various methods including applying a linear formula or using a look-up table that maps temperatures to polling parameter adjustments. The status polling component polls the memory device for status information about array operations being performed at the memory device in accordance with the adjusted polling parameters.

The memory sub-system eliminates the inefficiencies of conventional fixed-timing approaches by implementing temperature-aware polling adjustments, which can be customized for different operation types (read, program, or erase) and even on a per-die basis for multi-die packages. This temperature-based adjustment mechanism reduces unnecessary status polling operations while ensuring timely detection of operation completion, leading to more efficient utilization of the ONFI bus and improved system performance. In addition, the memory sub-system reduces latency penalties by adapting initial delay parameters and polling intervals to account for temperature-induced changes in program, erase, and read operation times, which can vary significantly between hot and cold temperature conditions.

FIG. 1 illustrates an example computing environment 100 that includes a memory sub-system 110, in accordance with some embodiments of the present disclosure.

The memory sub-system 110 can include media, such as one or more volatile memory devices (e.g., memory device 140), one or more non-volatile memory devices (e.g., memory device 130), or a combination of such.

A memory sub-system 110 can be a memory device, a memory module, or a hybrid of a memory device and memory module. Examples of a memory device include an SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as single level cells (SLCs), multi-level cells (MLCs) (e.g., triple level cells [TLCs], or quad-level cells [QLCs]). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 115 can communicate with the memory devices 130 to perform operations such as reading data, writing data, or erasing data at the memory devices 130 and at other such operations. For example, the memory sub-system controller 115 can be coupled to any one or more of the memory device 130 or 140 over a communication interface 125. The communication interface 125 comprises multiple channels to facilitate communication between the memory sub-system controller 115 and the memory devices 130 and 140. In an example, the memory device 130 includes multiple dies and each die of the memory device 130 uses one of the channels to communicate with the memory sub-system controller 115. That is, a given die of the memory device 130 may communicate (e.g., send and receive data and commands) with the memory sub-system controller 115 over a channel of the communication interface dedicated to the die. In some examples, the communication interface 125 comprises a data transfer interface such as an Open Nand Flash Interface (ONFI) bus. In some examples, the communication interface 125 comprises a separate command-address (SCA) bus for the memory sub-system controller 115 to send commands to the memory devices 130 and 140.

The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory subsystem 110 in FIG. 1 has been illustrated as including the memory sub-system controller 115, in another embodiment of the present disclosure, a memory subsystem 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a status polling component 113 that is responsible for performing status polling of the memory device 130. In performing status polling, the status polling component 113 sends one or more commands comprising requests for status information (also referred to as “application status requests”) regarding array operations being performed at the memory device 130 to the memory device 130 via the communication interface 125. In some examples, the status polling component 113 sends the one or more commands to the memory device 130 via an ONFI bus. In some examples, the status polling component 113 sends the one or more commands to the memory device via an SCA bus. The status polling component 113 obtains status information (e.g., from a status register) based on the polling. The status polling component 113 may determine a temperature of the memory device 130 (or at least a portion thereof) and adjust one or more status polling parameters based on the temperature. Further details regarding the status polling component 113 are discussed below.

In some embodiments, the memory sub-system controller 115 includes at least a portion of the status polling component 113. For example, the memory subsystem controller 115 can include a processor 117 (processing device) configured to execute instructions stored in local memory 119 (e.g., firmware) for performing the operations described herein. In some embodiments, the status polling component 113 is part of the host system 120, an application, or an operating system. Further details regarding the status polling component 113 are discussed below.

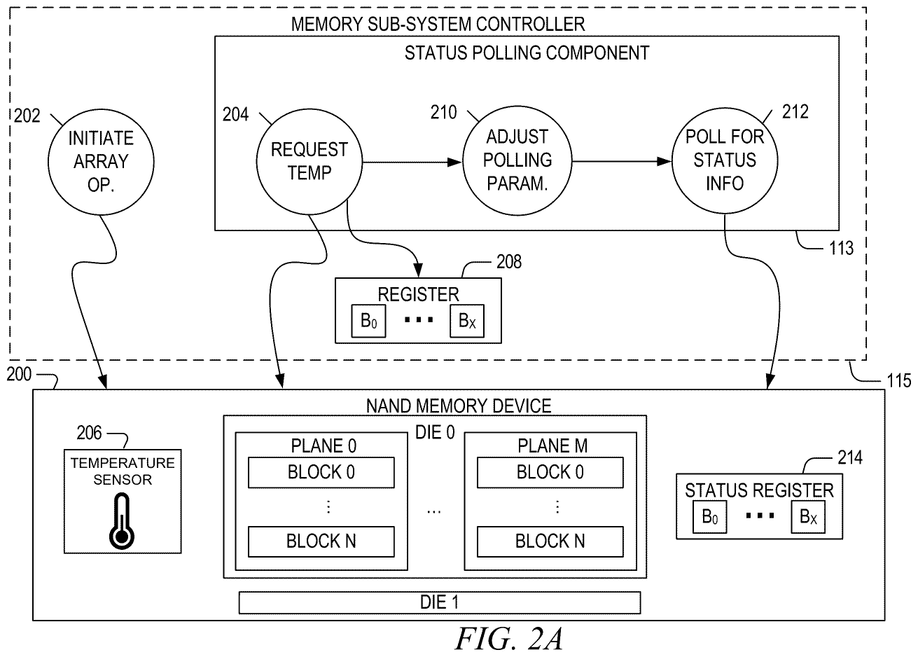

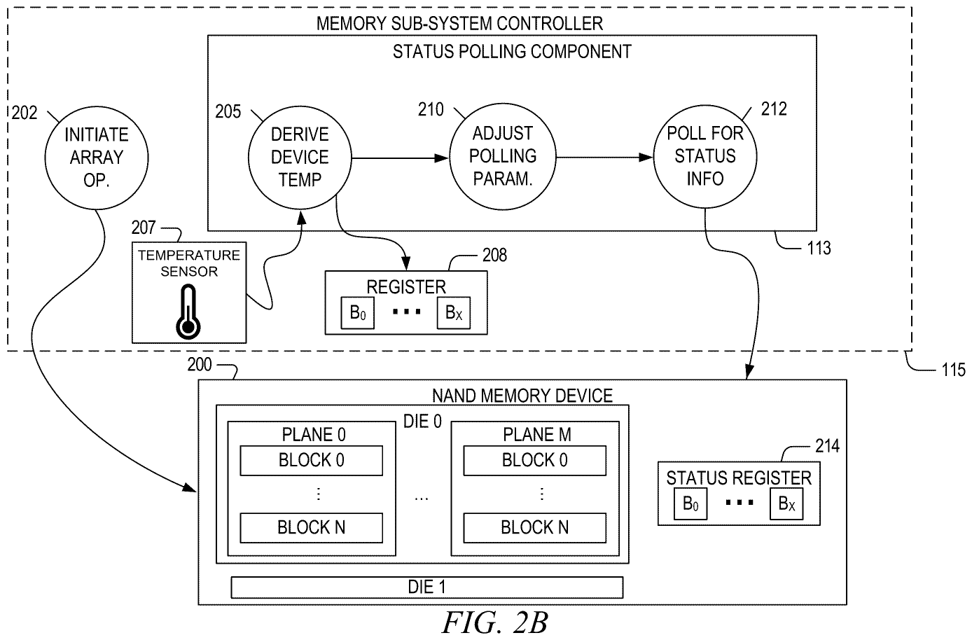

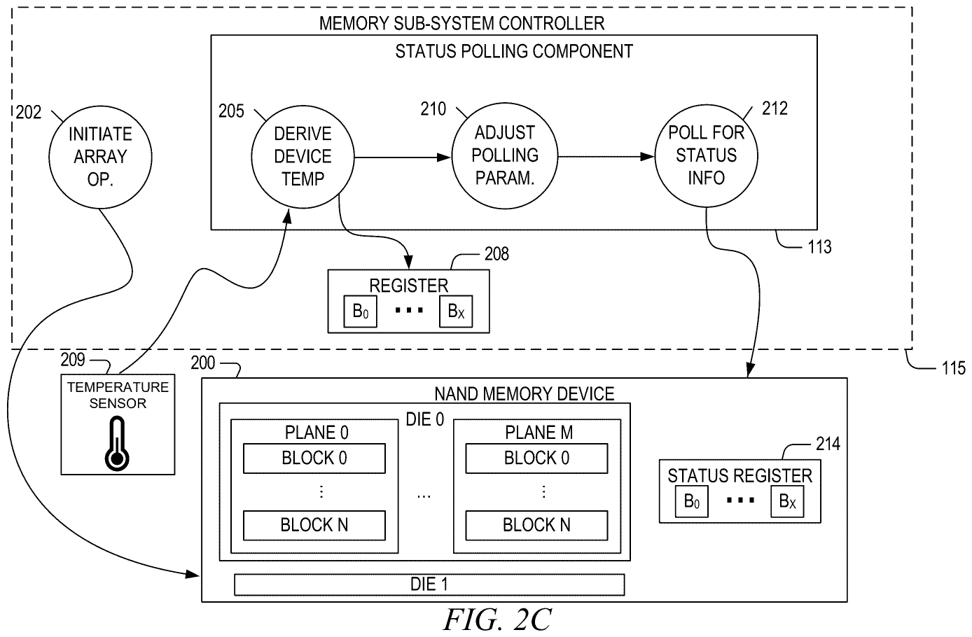

FIGS. 2A, 2B, and 2C are data flow diagrams illustrating interactions between components in the memory sub-system in performing enhanced status polling of a memory device, in accordance with some examples. In the example illustrated in FIGS. 2A, 2B, and 2C, the memory device 200 is an example memory device 130 in the example form of a NAND memory device.

The memory device 200 includes multiple NAND dies. Each die may include one or more planes, and each plane includes multiple blocks such as block₀-block₈ illustrated in FIGS. 2A, 2B, and 2C. Each block includes a two- or three-dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory includes an SLC portion that includes multiple SLCs and a QLC portion that includes multiple QLCs.

As noted above, each NAND cell stores data in the form of the threshold voltage (VT) of the transistor. The range of threshold voltages of a memory cell can be divided into a number of regions based on the number of bits stored by the cell where each region corresponds to a value that can be represented by the cell. More specifically, each region corresponds to a read voltage level (also referred to simply as “read level”) and each read voltage level decodes into a multi-bit value. For example, a TLC NAND flash cell can be at one of eight read levels (L0, L1, L2, L3, L4, L5, L6, or L7) and each read level decodes into a 3-bit value that is stored in the flash cell (e.g., 111, 110, 100, 000, 010, 011, 001, and 101).

As shown in both FIGS. 2A, 2B, and 2C, at operation 202, the memory sub-system controller 115 initiates an array operation at the NAND memory device 200. For example, the memory sub-system controller 115 may initiate a read operation to read data from the NAND memory device 200, a programming operation to program (write) data to the NAND memory device 200, or an erase operation to erase data from the NAND memory device 200.

In the example illustrated by FIG. 2A, the status polling component 113 retrieves, from the memory device 200, temperature data comprising a temperature of the memory device 200 (or a portion thereof). The temperature of the memory device 200 included in the temperature data may comprise a single temperature value (e.g., 30°) or a range of temperature values (e.g., 28°-32°). In an example, as shown, at operation 204, the status polling component 113 may send one or more commands to request temperature data from the memory device 200 generated by a temperature sensor 206 of the memory device 200. The status polling component 113 stores the temperature data in an internal register 208. In some examples, the memory device 200 may store temperature data in a register such as status register 214 or another register based on the one or more commands from the status polling component 113 and the status polling component 113 obtains the temperature data by reading it from the register of the memory device 200. Storing the temperature data may comprise storing a single value corresponding to a single temperature value, storing a single value corresponding to a range of temperature values, or storing multiple values corresponding to a range of temperature values. In some examples, the temperature data received from the temperature sensor 206 comprises a single temperature value while storing the temperature data comprises storing a value corresponding to a range of temperature values in which the single temperature value is included.

In the example illustrated by FIG. 2B, the status polling component 113 derives a temperature of the memory device 200 (or portion thereof) from temperature data output by a temperature sensor 207 of the memory sub-system controller 115, while in the example illustrated by FIG. 2C, the status polling component 113 derives a temperature of the memory device 200 from a standalone temperature sensor 209. The derived temperature of the memory device 200 may comprise a single temperature value or a particular range of temperature values. That is, the status polling component 113 can use temperature output data from the temperature sensor or the standalone temperature sensor 209 (depending on the example) to determine a specific temperature of the memory device 200 (e.g., 30°) or a range of temperatures (e.g., 28°-32°) in which the temperature of the memory device 200 is included. In the example of FIG. 2B, as shown, at operation 205, the status polling component 113 obtains output data (temperature data comprising a temperature of the memory sub-system controller 115) from the temperature sensor 207 and the status polling component 113 applies an offset to the output data (e.g., by adding a value of the offset to a temperature of the memory sub-system controller 115) to derive the temperature of the memory device 200. The offset applied to the output data of the temperature sensor 207 may be based on a physical distance between the memory sub-system controller 115 and the memory device 200. In this example, the status polling component 113 stores the derived temperature in the register 208.

Similarly, in the example of FIG. 2C, at operation 205, the status polling component 113 obtains output data (temperature data comprising a temperature of the memory sub-system controller 115) from the standalone temperature sensor 209 and the status polling component 113 applies an offset to the output data (e.g., by adding a value of the offset to a temperature of the memory sub-system controller 115) to derive the temperature of the memory device 200. The offset applied to the output data of the standalone temperature sensor 209 may be based on a physical distance between the standalone temperature sensor 209 and the memory device 200. As with the example of FIG. 2B, in this example, the status polling component 113 stores the derived temperature in the register 208.

With reference to FIGS. 2A, 2B, and 2C, at operation 210, the status polling component 113 adjusts one or more status polling parameters based on the temperature of the memory device 200 (or a portion thereof) thereby resulting in one or more adjusted status polling parameters. The polling parameters comprise an initial delay parameter and a polling interval parameter. The initial delay parameter defines a delay (a first time period) between initiating the array operation at the memory device and sending the initial operation status command to the memory device. The polling interval parameter defines an interval (a second time period) between sending follow-up operation status commands. Thus, the adjusting of the one or more status polling parameters can include adjusting the initial delay parameter and/or adjusting the polling interval parameter. In some instances, the status polling component 113 adjusts the polling interval parameter such that no further follow-up operation status requests are sent to the memory device 200. In adjusting a particular polling parameter, the status polling component 113 may access a look-up table to determine polling parameter adjustments. That is, a look-up table comprising a mapping between memory device temperatures and polling parameter adjustments may be used by the status polling component 113 in adjusting the polling parameters.

At operation 212, the status polling component 113 polls the NAND memory device 200 for status information associated with the array operation in accordance with the adjusted status polling parameters. In general, polling includes sending operation status requests to the NAND memory device 200 and the NAND memory device 200, in turn, responds by adding status information to the status register 214. In some examples, the status information may indicate whether the memory device 200 is busy performing the array operation or available to perform other operations. In some examples, the status information can include any one or more of a predicted time to completion of the array operation or progress information about the array operations such as a loop count.

In this example, the status polling component 113 sends an initial operation status request to the NAND memory device 200 after a delay defined by an adjusted or default initial delay parameter and may subsequently send one or more follow-up status requests at an interval defined by a default or adjusted polling interval parameter, depending on the outcome of subsequent operations. In some examples, the status polling component 113 sends commands comprising operations status requests to the memory device 200 via an ONFI bus (not shown). In some examples, the status polling component 113 sends commands comprising operations status requests to the memory device 200 via an SCA bus (not shown).

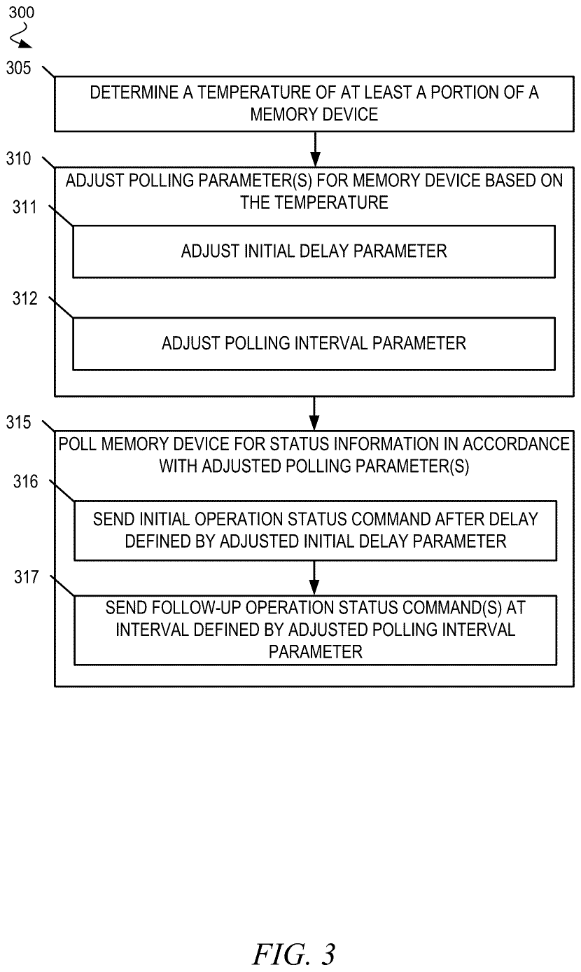

FIG. 3 is a flow diagram illustrating an example method 300 for performing enhanced status polling of a memory device, in accordance with some examples. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the status polling component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment; other process flows are possible.

At operation 305, a processing device determines a temperature of at least a portion of a memory device. In a first example, the memory device comprises a temperature sensor and determining the temperature includes polling the memory device for temperature data generated by the temperature sensor. The polling of the memory device for the temperature data comprises sending commands to the memory device at a predetermined interval to request the temperature data.

In a second example, the processing device comprises a temperature sensor and the processing device derives the temperature of the memory device therefrom. For example, the processing device may determine the temperature by applying an offset to temperature data output by the temperature sensor of the processing device. The offset applied to the output data of the temperature sensor may, for example, be based on a physical distance between the processing device and the memory device.

In a third example, the memory device and the processing device are part of a memory subsystem that also includes a standalone temperature sensor that is neither part of the memory device nor the processing device. In this example, the processing device derives the temperature of the memory device therefrom. For example, the processing device may determine the temperature by applying an offset to temperature data output by the standalone temperature sensor. The offset applied to the output data of the temperature sensor may, for example, be based on a physical distance between the standalone temperature sensor and the memory device.

Consistent with both examples, the processing device may store temperature data (comprising the temperature of at least the portion of the memory device) in an internal register and access the temperature data therefrom.

At operation 310, the processing device adjusts one or more status polling parameters based on the temperature thereby resulting in one or more adjusted status polling parameters. The polling parameters comprise an initial delay parameter and a polling interval parameter. The initial delay parameter defines a delay (a first time period) between initiating the array operation at the memory device and sending the initial operation status command to the memory device. The polling interval parameter defines an interval (a second time period) between sending follow-up operation status commands. Thus, as shown, the adjusting of the one or more status polling parameters can include adjusting the initial delay parameter (operation 311) and/or adjusting the polling interval parameter (operation 312).

In some examples, the adjusting of the one or more status polling parameters comprises applying a formula (e.g., a simple linear formula) to adjust the initial polling delay parameter after an array operation is initiated based on the temperature of at least the portion of the memory device. In some examples, the adjusting of the one or more status polling parameters can include accessing a look-up table comprising a mapping between memory device temperatures and status polling parameter adjustments.

At operation 315, the processing device polls the memory device for status information about an array operation (e.g., a read operation, a programming operation, or an erase operation) being performed at the memory device in accordance with the one or more adjusted polling parameters. Polling generally includes sending operation status commands to request the status information from the memory device. More specifically, polling includes sending an initial operation status command to request status information about an array operation after a delay defined by the initial polling delay parameter after the array operation is initiated at the memory device and sending one or more follow-up operation status commands to the memory device at an interval defined by the polling interval parameter. Hence, the polling of the memory device in accordance with the one or more adjusted polling parameters can include sending an initial operation status command after a delay defined by an adjusted initial delay parameter (operation 316) and/or sending one or more follow-up operation status commands at an interval defined by an adjusted polling interval parameter (operation 317).

Consistent with some examples, status polling parameters may be adjusted based on array operation type. For example, the processing device may adjust a first polling parameter corresponding to erase operations based on the temperature of the memory device, adjust a second polling parameter corresponding to programming operations based on the temperature of the memory device, and adjust a third polling parameter corresponding to read operations based on the temperature of the memory device. Consistent with these examples, the processing device polls the memory device for status information about erase operations in accordance with the adjusted first polling parameter while polling the memory device for status information about programming operations in accordance with the adjusted second polling parameter and about read operations in accordance with the adjusted third polling parameter. In this way, polling parameters may be different for the different array operation types. That is, different initial delays and/or polling intervals (e.g., determined based on temperature data) can be used for status polling for different array operation types.

Consistent with some examples, the processing device may adjust polling parameters on a per-die basis based more specifically on a temperature of each die of the memory device. For example, the memory device may determine a first temperature corresponding to a first die of the memory device, adjust one or more polling parameters for the first die of the memory device based on the first temperature, and poll the memory device for status information about an array operation being performed at the first die of the memory device in accordance with the adjusted polling parameters for the first die. Consistent with these examples, the processing device may also determine a second temperature corresponding to a second die of the memory device, adjust one or more polling parameters for the second die of the memory device based on the second temperature, and poll the memory device for status information about an array operation being performed at the second die of the memory device in accordance with the adjusted polling parameters for the second die of the memory device.

Described implementations of the subject matter can include one or more features, alone or in combination, as illustrated below by way of example.

Example 1. A memory sub-system comprising: a memory device; a processing device, operatively coupled with the memory device, to perform operations comprising: determining a temperature of a least a portion of the memory device; adjusting one or more polling parameters for the memory device based on the temperature, the adjusting of the one or more polling parameters resulting in one or more adjusted polling parameters; and polling the memory device for status information about an array operation being performed at the memory device in accordance with the one or more adjusted polling parameters.

Example 2. The memory sub-system of Example 1, wherein the memory device comprises a temperature sensor to generate temperature data, wherein determining the temperature comprises polling the memory device for the temperature data generated by the temperature sensor.

Example 3. The memory sub-system of any one or more of Examples 1 or 2, wherein the polling of the memory device for the temperature data comprises sending commands to the memory device at a predetermined interval to request the temperature data.

Example 4. The memory sub-system of any one or more of Examples 1-3, wherein the temperature data generated by the temperature sensor is stored in an internal register of the processing device, wherein the determining of the temperature comprises accessing the temperature data from the internal register.

Example 5. The memory sub-system of any one or more of Examples 1-4, wherein the processing device comprises a temperature sensor, wherein the determining of the temperature is based on temperature data output by the temperature sensor of the processing device.

Example 6. The memory sub-system of any one or more of Examples 1-5, wherein determining of the temperature comprises applying an offset to the temperature data of the temperature sensor of the processing device.

Example 7. The memory sub-system of any one or more of Examples 1-6, comprising a temperature sensor to generate temperature data, wherein the determining of the temperature is based on temperature data output by the temperature sensor.

Example 8. The memory sub-system of any one or more of Examples 1-7, wherein: the memory device comprises multiple dies, the temperature is a first temperature corresponding to a first die from the multiple dies, the adjusting of the one or more polling parameters comprises adjusting a first polling parameter corresponding to the first die, the array operation is a first array operation being performed at the first die of the memory device, polling the memory device for status information about the array operation being performed at the memory device comprises polling the memory device for status information about the first array operation being performed at the first die based on the adjusting of the first polling parameter.

Example 9. The memory sub-system of any one or more of Examples 1-8, wherein the operations comprise: determining a second temperature corresponding to a second die of the memory device; adjusting a second polling parameter corresponding to the second die of the memory device based on the second temperature; and polling the memory device for status information about a second array operation being performed at the second die of the memory device based on the adjusting of the second polling parameter.

Example 10. The memory sub-system of any one or more of Examples 1-9, wherein: the adjusting of the one or more polling parameters comprises adjusting an initial delay parameter that defines a delay between initiating the array operation at the memory device and sending an initial operation status command to the memory device; and the polling of the memory device comprising sending the initial operation status command to the memory device after the array operation is initiated at the memory device in accordance with the delay defined by the adjusted initial delay parameter.

Example 11. The memory sub-system of of any one or more of Examples 1-10, the adjusting of the one or more polling parameters comprises adjusting a polling interval parameter that defines an interval for sending follow-up operation status commands after sending an initial status command; and the polling of the memory device comprising: sending the initial operation status command to the memory device after the array operation is initiated; and sending follow-up operation status commands to the memory device at the interval defined by the adjusted polling interval parameter.

Example 12. The memory sub-system of any one or more of Examples 1-11, wherein the adjusting of the one or more polling parameters comprises accessing a look-up table comprising a mapping between temperatures and polling parameter adjustments.

Example 13. The memory sub-system of any one or more of Examples 1-12, wherein: the adjusting of the one or more polling parameters comprises: adjusting a first polling parameter corresponding to erase operations; adjusting a second polling parameter corresponding to programming operations; and adjusting a third polling parameter corresponding to read operations; the array operation is a first array operation comprising an erase operation; the polling of the memory device comprises polling the memory device for status information about the first array operation in accordance with the first polling parameter; the operations comprise: polling the memory device for status information about a second array operation in accordance with the second polling parameter, the second array operation comprising a programming operation; and polling the memory device for status information about a third array operation in accordance with the third polling parameter, the third array operation comprising a read operation.

Example 14. A method comprising: accessing, by a processing device, temperature data from an internal register of the processing device, the temperature data comprising a temperature of at least a portion of a memory device; adjusting, by the processing device, one or more polling parameters for the memory device based on the temperature data, the adjusting of the one or more polling parameters resulting in one or more adjusted polling parameters; and polling, by the processing device, the memory device for status information about an array operation being performed at the memory device in accordance with the one or more adjusted polling parameters.

Example 15.The method of Example 14, wherein the memory device comprises a temperature sensor to generate the temperature data, wherein the method comprises polling the memory device for the temperature data generated by the temperature sensor, wherein the polling of the memory device for the temperature data comprises sending commands to the memory device at a predetermined interval to request the temperature data.

Example 16.The method of any one or more of Examples 14 or 15, wherein the processing device comprises a temperature sensor, wherein the temperature data is based on output data of the temperature sensor of the processing device, wherein the method comprises determining the temperature of at least the portion of the memory device by applying an offset to the output data of the temperature sensor of the processing device.

Example 17. The method of any one or more of Examples 14-16, wherein: the memory device comprises multiple dies, the temperature data is first temperature data corresponding to a first die from the multiple dies, the adjusting of the one or more polling parameters comprises adjusting a first polling parameter corresponding to the first die, the array operation is a first array operation being performed at the first die of the memory device, the polling of the memory device for status information about the array operation being performed at the memory device comprises polling the memory device for status information about the first array operation being performed at the first die based on the adjusting of the first polling parameter, the method comprises: determining a second temperature corresponding to a second die of the memory device; adjusting a second polling parameter corresponding to the second die of the memory device based on the second temperature; and polling the memory device for status information about a second array operation being performed at the second die of the memory device based on the adjusting of the second polling parameter.

Example 18. The method of any one or more of Examples 14-17, wherein: the adjusting of the one or more polling parameters comprises at least one of: adjusting an initial delay parameter that defines a delay between initiating the array operation at the memory device and sending an initial operation status command to the memory device; and adjusting a polling interval parameter that defines an interval for sending follow-up operation status commands after sending an initial status command; and the polling of the memory device comprises: sending the initial operation status command to the memory device after the array operation is initiated at the memory device in accordance with the delay defined by the initial delay parameter; and sending follow-up operation status commands to the memory device at the interval defined by the polling interval parameter.

Example 19. A computer-readable storage medium comprising instructions that, when executed by a processing device, configure the processing device to perform operations comprising: determining a temperature of at least a portion of a memory device; adjusting one or more polling parameters for the memory device based on the temperature, the adjusting of the one or more polling parameters comprising adjusting at least one of a initial delay parameter or a polling interval parameter, the initial delay parameter defining a delay between initiating an array operation at the memory device and sending an initial operation status command to the memory device, the polling interval parameter that defines an interval for sending follow-up operation status commands after sending an initial status command, the adjusting of the one or more polling parameters resulting in one or more adjusted polling parameters; and polling the memory device for status information about an array operation being performed at the memory device in accordance with the one or more adjusted polling parameters.

Example 20. The computer-readable storage medium of Example 19, wherein: the adjusting of the one or more polling parameters comprises at least one of: adjusting an initial delay parameter that defines a delay between initiating the array operation at the memory device and sending an initial operation status command to the memory device; and adjusting a polling interval parameter that defines an interval for sending follow-up operation status commands after sending an initial status command; and the polling of the memory device comprises: sending the initial operation status command to the memory device after the array operation is initiated at the memory device in accordance with the delay defined by the initial delay parameter; and sending follow-up operation status commands to the memory device at the interval defined by the polling interval parameter.

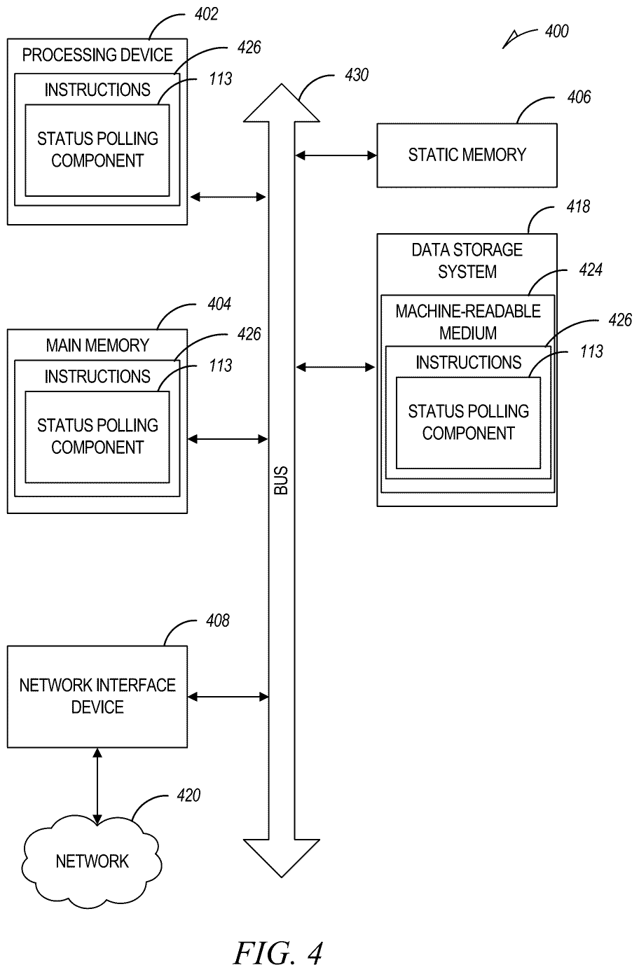

FIG. 4 illustrates an example machine in the form of a computer system within which a set of instructions can be executed for causing the machine to perform any one or more of the methodologies discussed herein. FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the status polling component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., ROM, flash memory, DRAM such as SDRAM or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an ASIC, a FPGA, a digital signal processor (DSP), network processor, or the like. The processing device 402 is configured to execute instructions 426 for performing the operations and steps discussed herein. The computer system 400 can further include a network interface device 408 to communicate over a network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a status polling component (e.g., the status polling component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device;
a processing device, operatively coupled with the memory device, to perform operations comprising:
determining a temperature of a least a portion of the memory device;
adjusting one or more polling parameters for the memory device based on the temperature, the adjusting of the one or more polling parameters resulting in one or more adjusted polling parameters; and
polling the memory device for status information about an array operation being performed at the memory device in accordance with the one or more adjusted polling parameters.

2. The memory sub-system of claim 1, wherein the memory device comprises a temperature sensor to generate temperature data, wherein determining the temperature comprises polling the memory device for the temperature data generated by the temperature sensor.

3. The memory sub-system of claim 2, wherein the polling of the memory device for the temperature data comprises sending commands to the memory device at a predetermined interval to request the temperature data.

4. The memory sub-system of claim 2, wherein the temperature data generated by the temperature sensor is stored in an internal register of the processing device, wherein the determining of the temperature comprises accessing the temperature data from the internal register.

5. The memory sub-system of claim 1, wherein the processing device comprises a temperature sensor, wherein the determining of the temperature is based on temperature data output by the temperature sensor of the processing device.

6. The memory sub-system of claim 5, wherein determining of the temperature comprises applying an offset to the temperature data of the temperature sensor of the processing device.

7. The memory sub-system of claim 1, comprising a temperature sensor to generate temperature data, wherein the determining of the temperature is based on temperature data output by the temperature sensor.

8. The memory sub-system of claim 1, wherein:
the memory device comprises multiple dies,
the temperature is a first temperature corresponding to a first die from the multiple dies,
the adjusting of the one or more polling parameters comprises adjusting a first polling parameter corresponding to the first die,
the array operation is a first array operation being performed at the first die of the memory device,
polling the memory device for status information about the array operation being performed at the memory device comprises polling the memory device for status information about the first array operation being performed at the first die based on the adjusting of the first polling parameter.

9. The memory sub-system of claim 8, wherein the operations comprise:
determining a second temperature corresponding to a second die of the memory device;
adjusting a second polling parameter corresponding to the second die of the memory device based on the second temperature; and
polling the memory device for status information about a second array operation being performed at the second die of the memory device based on the adjusting of the second polling parameter.

10. The memory sub-system of claim 1, wherein:
the adjusting of the one or more polling parameters comprises adjusting an initial delay parameter that defines a delay between initiating the array operation at the memory device and sending an initial operation status command to the memory device; and
the polling of the memory device comprising sending the initial operation status command to the memory device after the array operation is initiated at the memory device in accordance with the delay defined by the adjusted initial delay parameter.

11. The memory sub-system of claim 1,
the adjusting of the one or more polling parameters comprises adjusting a polling interval parameter that defines an interval for sending follow-up operation status commands after sending an initial status command; and
the polling of the memory device comprising:
sending the initial operation status command to the memory device after the array operation is initiated; and
sending follow-up operation status commands to the memory device at the interval defined by the adjusted polling interval parameter.

12. The memory sub-system of claim 11, wherein the adjusting of the one or more polling parameters comprises accessing a look-up table comprising a mapping between temperatures and polling parameter adjustments.

13. The memory sub-system of claim 11, wherein:
the adjusting of the one or more polling parameters comprises:
adjusting a first polling parameter corresponding to erase operations;
adjusting a second polling parameter corresponding to programming operations; and
adjusting a third polling parameter corresponding to read operations;
the array operation is a first array operation comprising an erase operation;
the polling of the memory device comprises polling the memory device for status information about the first array operation in accordance with the first polling parameter;
the operations comprise:
polling the memory device for status information about a second array operation in accordance with the second polling parameter, the second array operation comprising a programming operation; and
polling the memory device for status information about a third array operation in accordance with the third polling parameter, the third array operation comprising a read operation.

14. A method comprising:
accessing, by a processing device, temperature data from an internal register of the processing device, the temperature data comprising a temperature of at least a portion of a memory device;
adjusting, by the processing device, one or more polling parameters for the memory device based on the temperature data, the adjusting of the one or more polling parameters resulting in one or more adjusted polling parameters; and
polling, by the processing device, the memory device for status information about an array operation being performed at the memory device in accordance with the one or more adjusted polling parameters.

15. The method of claim 14, wherein the memory device comprises a temperature sensor to generate the temperature data, wherein the method comprises polling the memory device for the temperature data generated by the temperature sensor, wherein the polling of the memory device for the temperature data comprises sending commands to the memory device at a predetermined interval to request the temperature data

16. The method of claim 14, wherein the processing device comprises a temperature sensor, wherein the temperature data is based on output data of the temperature sensor of the processing device, wherein the method comprises determining the temperature of at least the portion of the memory device by applying an offset to the output data of the temperature sensor of the processing device.

17. The method of claim 14, wherein:
the memory device comprises multiple dies,
the temperature data is first temperature data corresponding to a first die from the multiple dies,
the adjusting of the one or more polling parameters comprises adjusting a first polling parameter corresponding to the first die,
the array operation is a first array operation being performed at the first die of the memory device,
the polling of the memory device for status information about the array operation being performed at the memory device comprises polling the memory device for status information about the first array operation being performed at the first die based on the adjusting of the first polling parameter,
the method comprises:
determining a second temperature corresponding to a second die of the memory device;
adjusting a second polling parameter corresponding to the second die of the memory device based on the second temperature; and
polling the memory device for status information about a second array operation being performed at the second die of the memory device based on the adjusting of the second polling parameter.

18. The method of claim 14, wherein:
the adjusting of the one or more polling parameters comprises at least one of:
adjusting an initial delay parameter that defines a delay between initiating the array operation at the memory device and sending an initial operation status command to the memory device; and
adjusting a polling interval parameter that defines an interval for sending follow-up operation status commands after sending an initial status command; and
the polling of the memory device comprises:
sending the initial operation status command to the memory device after the array operation is initiated at the memory device in accordance with the delay defined by the initial delay parameter; and
sending follow-up operation status commands to the memory device at the interval defined by the polling interval parameter.

19. A computer-readable storage medium comprising instructions that, when executed by a processing device, configure the processing device to perform operations comprising:
determining a temperature of at least a portion of a memory device;
adjusting one or more polling parameters for the memory device based on the temperature, the adjusting of the one or more polling parameters comprising adjusting at least one of a initial delay parameter or a polling interval parameter, the initial delay parameter defining a delay between initiating an array operation at the memory device and sending an initial operation status command to the memory device, the polling interval parameter that defines an interval for sending follow-up operation status commands after sending an initial status command, the adjusting of the one or more polling parameters resulting in one or more adjusted polling parameters; and
polling the memory device for status information about an array operation being performed at the memory device in accordance with the one or more adjusted polling parameters.

20. The computer-readable storage medium of claim 19, wherein:
the adjusting of the one or more polling parameters comprises at least one of:
adjusting an initial delay parameter that defines a delay between initiating the array operation at the memory device and sending an initial operation status command to the memory device; and
adjusting a polling interval parameter that defines an interval for sending follow-up operation status commands after sending an initial status command; and
the polling of the memory device comprises:
sending the initial operation status command to the memory device after the array operation is initiated at the memory device in accordance with the delay defined by the initial delay parameter; and
sending follow-up operation status commands to the memory device at the interval defined by the polling interval parameter.
